(19) United States
(12) Patent Application Publication
(10) Pub. No.: US 2018/0285567 A1
(43) Pub. Date: Oct. 4, 2018

(54) Methods and Systems for Malware Analysis and Gating Logic

(71) Applicant: QUALCOMM Incorporated, San Diego, CA (US)

(72) Inventor: Arun Raman, Milpitas, CA (US)

(21) Appl. No.: 15/604,889

(22) Filed: May 25, 2017

Related U.S. Application Data
(60) Provisional application No. 62/479,900, filed on Mar. 31, 2017.

(51) Int. Cl. G06F 21/56; G06F 11/36

(52) U.S. Cl. CPC G06F 21/566; G06F 11/3668; G06F 21/53; G06F 21/563; G06F 2221/033

(57) ABSTRACT

A network and its devices may be protected from non-benign behavior, malware, and cyber attacks by configuring a computing device to repeatedly or recursively “canonicalizing” a software application program (e.g., performing compiler transformations, peeling off layers of obfuscation and junk, etc.) until the core functionality of the software application is revealed. The computing device may analyze the revealed core functionality to determine whether the software application is benign or non-benign. For example, the computing device may unpack the software application in layers, perform control flow dependency analysis operations and/or data-flow dependency analysis operations on each layer to generate analysis results, use the information gained from the analysis operations to identify inputs that should be used to exercise the application, use the identified inputs to exercise the application and collect behavior information, and use the collected behavior information to evaluate each unpacked layer and determine whether the software application is non-benign.

### RELATED APPLICATIONS

This application claims the benefit of priority to U.S. Provisional Application No. 62/479,900, entitled “Methods and Systems for Malware Analysis and Gating Logic” filed Mar. 31, 2017, the entire contents of which are hereby incorporated by reference.

### BACKGROUND

Cellular and wireless communication technologies have seen explosive growth over the past several years. Wireless service providers now offer a wide array of features and services that provide their users with unprecedented levels of access to information, resources and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, mobile device users frequently use their devices to purchase goods, send and receive sensitive communications, pay bills, manage bank accounts, and conduct other sensitive transactions. Due to these trends, mobile devices are becoming the next frontier for malware and cyber-attacks. Accordingly, new and improved security solutions that better protect resource-constrained computing devices, such as mobile and wireless devices, will be beneficial to consumers.

### SUMMARY

Various embodiments include methods of protecting computing devices from non-benign software applications by canonicalizing a software package to determine the core functionality of its associated software application and determining whether the core functionality is non-benign. A processor in a computing device may be configured to perform canonicalization operations on a software application until a behavior trace matches a trace stored in memory or until a core functionality of the software application is accessible for analysis, and determine whether the core functionality is non-benign in response to determining that the core functionality of the software application is accessible for analysis. The processor may determine that the core functionality of the software application is revealed and thus accessible for analysis by progressively generating canonical representations until further canonical representations provide no further benefit to the analysis. Specifically, the processor may progressively generate canonical representations that each characterize a functionality of the software application at a higher level of detail and/or at a level that is closer to the core functionality of the software application than the preceding canonical representation. The processor may continue generating canonical representations until a generated canonical representation characterizes the functionality at a level of detail that is no higher than the preceding generated canonical representation.

Alternatively, processor may determine that the core functionality of the software application is revealed and thus accessible for analysis by repeatedly performing a compiler transformation operation that de-obfuscates a software package associated with the software application in layers, with each subsequent layer exhibiting less obfuscation than the preceding layer. The processor may continue performing the compiler transformation operation until the processor determines that further de-obfuscation is not possible on the software package or that the performance of another compiler transformation operation will not produce a layer that is less obfuscated than the preceding layer.

In an embodiment, the method may include classifying the software application as benign or non-benign in response to determining that the behavior trace matches a trace stored in memory. In a further embodiment, performing canonicalization operations, via the processor, on the software package until a behavior trace matches a trace stored in memory or until a core functionality of the software application is accessible may include repeatedly performing operations that include performing analysis operations based on the behavior trace to generate analysis results, canonicalizing the software application to generate a canonicalized representation of the software application, using the analysis results to further canonicalize the software application and generate a more detailed canonicalized representation of the software application, and updating the behavior trace by using the more detailed canonicalized representation to exercise the software application in a replicated computing environment. In an embodiment, the method may include repeatedly performing the operations until the behavior trace matches a trace stored in memory or until the core functionality of the software application is revealed.

Some embodiments may further include canonicalizing the software application to generate a first canonicalized representation of the software application, generating an executable binary representation of the software application based on the first canonicalized representation, and exercising the software application by executing the generated executable binary representation in the replicated computing environment to generate an initial behavior trace. Some embodiments may further include determining whether the initial behavior trace matches a trace stored in memory, and performing analysis operations based on the initial behavior trace to generate analysis results in response to determining that the initial behavior trace does not match any trace stored in memory. In some embodiments, canonicalizing the software package to generate the first canonicalized representation of the software application may include a code transformation operation, a canonical code ordering operation, a semantic no-operation removal operation, a deadcode elimination operation, a canonical register naming operation, or a code unpacking operation.

In some embodiments, canonicalizing the software application to generate the first canonicalized representation of the software application may include performing a compiler transformation operation that de-obfuscates a software package associated with the software application. In some embodiments, canonicalizing the software application to generate the first canonicalized representation of the software application may include unpacking the software application in layers. In such embodiments, repeatedly performing the operations of performing the analysis operations based on the behavior trace to generate the analysis results, canonicalizing the software application to generate a canonicalized representation of the software application, using the analysis results to further canonicalize the software application and generate the more detailed canonicalized representation of the software application, and updating the behavior trace by using the more detailed canonicalized representation to exercise the software application in a replicated computing environment until the behavior trace matches a trace stored in memory or until the core functionality of the software application is revealed may include evaluating each unpacked layer to determine whether the software application is non-benign.

In some embodiments, performing the analysis operations based on the behavior trace to generate the analysis results may include performing: a control flow dependency analysis operation; a data-flow dependency analysis operation; a symbolic analysis operation; or a concolic analysis operation. In some embodiments, using the analysis results to further canonicalize the software application and generate the more detailed canonicalized representation of the software application may include using information gained from performance of the control flow dependency analysis operation, the data-flow dependency analysis operation, the symbolic analysis operation, or the concolic analysis operation to identify inputs for exercising the software application. In some embodiments, using the more detailed canonicalized representation to further exercise the software application in the replicated computing environment to update the behavior trace may include using the identified inputs to further exercise the software application in the replicated computing environment.

In some embodiments, exercising the software application by executing the generated executable binary representation in the replicated computing environment to generate the behavior trace may include executing the generated executable binary representation via a sandboxed detonator component to generate the behavior trace.

Some embodiments may further include stress testing the software application in an emulator, collecting behavior information from behaviors exhibited by the software application during the stress testing, analyzing the collected behavior information to identify the core functionality of the software application, generating a signature based on the identified core functionality, and comparing the generated signature to another signature stored in a database of known behaviors.

In some embodiments, classifying the software application as benign or non-benign in response to determining that the behavior trace matches a trace stored in memory may include classifying the software application as benign in response to determining that the behavior trace matches a trace stored in a whitelist, and classifying the software application as non-benign in response to determining that the behavior trace matches a trace stored in a blacklist.

In some embodiments, determining whether the core functionality is non-benign in response to determining that the core functionality of the software application has been revealed may include performing the identified core functionality to collect behavior information, and using the collected behavior information to determine whether the core functionality is non-benign.

In some embodiments, determining whether the core functionality is non-benign in response to determining that the core functionality of the software application has been revealed may include the processor generating a machine learning classifier model, generating a behavior vector that characterizes an observed device behavior, applying the generated behavior vector to the generated machine learning classifier models to generate an analysis result, and determining whether the core functionality is non-benign based on the generated analysis result.

In some embodiments, determining whether the core functionality is non-benign in response to determining that the core functionality of the software application has been revealed may include performing static analysis operations to generate static analysis results, performing dynamic analysis operations to generate dynamic analysis results, and determining whether the core functionality is non-benign based on a combination of the static and dynamic analysis results.

In some embodiments, exercising the software application by executing the generated executable binary representation in the replicated computing environment to generate the behavior trace may include identifying a target activity of the software application, generating an activity transition graph based on the software application, identifying a sequence of activities that will lead to the identified target activity based on the activity transition graph, and triggering the identified sequence of activities.

Further embodiments may include a computing device having a memory and a processor that is coupled to the memory, in which the processor is configured with processor-executable instructions to perform operations of the methods summarized above. Further embodiments may include a computing device that include means for performing functions of the methods summarized above. Further embodiments may include a non-transitory processor-readable storage medium having stored thereon processor executable instructions configured to cause a processor of a computing device to perform operations of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating network components of an example telecommunication system that is suitable for use with various embodiments.

FIG. 2 is a block diagram illustrating example logical components and information flows in a system that includes a sandbox component in accordance with various embodiments.

FIG. 3 is an illustration of an object that could be repeatedly or recursively canonicalized and evaluated in accordance with the various embodiments.

FIG. 4 is an illustration of an application lifecycle timeline that illustrates timeframes for using different technologies and techniques to protect a computing device in accordance with various embodiments.

FIG. 5 is a process flow diagram illustrating a method for protecting client devices in accordance with an embodiment.

FIGS. 6 and 7 are process flow diagrams illustrating alternative methods for protecting client devices in accordance with other embodiments.

FIGS. 8A and 8B are block diagrams illustrating components and information flows in an embodiment system that could be configured to protect a corporate network and associated devices in accordance with various embodiments.

FIG. 9 is a component block diagram of a client computing device suitable for use with various embodiments.

FIG. 10 is a component block diagram of a server device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, the various embodiments include security systems and methods, as well as computing devices configured to implement the methods, for repeatedly or recursively “canonicalizing” a software application program (e.g., peeling off layers of obfuscation and junk, etc.) until the core functionality of the software application is revealed, and analyzing the core functionality in order to determine whether the software application is benign or non-benign.

The various embodiments include computing devices that are equipped with a security system. The security system may be configured to repeatedly or recursively apply or perform canonicalization operations on a software application program. After each iteration or application of the canonicalization operations (or at each level of canonicalization), the security system may exercise or stress test the software application program in a replicated computing environment (e.g., emulator, simulator, etc.). The security system may collect behavior information from the behaviors that are exhibited by the software application program during each exercise or stress test. The security system may analyze the collected behavior information to identify the software application program's core behaviors (or its core functionality, operations, etc.), and generate a trace or signature of the identified core behaviors. The security system may compare the trace/signature to the signatures of known behaviors in order to determine whether the identified core behavior matches a known behavior (i.e., a known good behavior or a known bad behavior). The security system may repeat the above-described operations as another iteration in the loop (or via recursion) in response to determining that the generated trace/signature does not match any of the known signatures (or that the identified core behavior does not match any known behaviors, etc.). The security system may classify the software application as benign (or non-benign) when the trace or signature of the identified core behavior matches a known good behavior (or a known bad behavior).

Various embodiments improve the functioning of a computing device by improving its security, performance, and power consumption characteristics. For example, by repeatedly and incrementally canonicalizing and stress testing the software application, the various embodiments allow the security system to intelligently peel off layers of obfuscation to more accurately identify or characterize the software application's core behaviors. By intelligently characterizing the core behavior, the computing device may identify and respond to non-benign software applications faster and more efficiently than conventional security methods. These operations improve the performance and functioning of the computing device by improving its performance and power consumption characteristics. Additional improvements to the functions, functionalities, and/or functioning of computing devices will be evident from the detailed descriptions of the embodiments provided below.

Phrases such as “performance degradation,” “degradation in performance” and the like may be used in this application to refer to a wide variety of undesirable operations and characteristics of a network or computing device, such as longer processing times, slower real time responsiveness, lower battery life, loss of private data, malicious economic activity (e.g., sending unauthorized premium short message service (SMS) message), denial of service (DoS), poorly written or designed software applications, malicious software, malware, viruses, fragmented memory, operations relating to commandeering the device or utilizing the device for spying or botnet activities, etc. Also, behaviors, activities, and conditions that degrade performance for any of these reasons are referred to herein as “not benign” or “non-benign.”

The terms “client computing device,” and “mobile computing device,” are used generically and interchangeably in this application, and refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar electronic devices which include a memory, a programmable processor operate under battery power such that power conservation methods are of benefit. While the various embodiments are particularly useful for mobile computing devices, which are resource-constrained systems, the embodiments are generally useful in any computing device that includes a processor and executes software applications.

The terms “sandbox” “detonator” “detonation boxes” and “payload analysis” may refer to similar components, although the functionality provided by each may differ. A “sandbox” may be virtual or real hardware device in which software applications may run without a significant risk of malware accessing or infecting a network or its constituent components. A “detonator” or “detonator box” may include hardware and/or software components that provide functionality for exercising particular functions of an application via a variety of inputs, and recording/analyzing the resulting behaviors (e.g., in a sandbox). Said another way, a detonator may be server computing device that is configured to systematically execute, explore, exercise, run, drive, or crawl a software application in a sandboxed, emulated or controlled environment. “Payload analysis” is a general term for analyzing the contents or payload of a communication or application, which may involve static analysis of the payload, operating the application/payload in a sandbox, and/or probing the functionality of the application/payload via a detonator.

Generally, enterprise security systems analyze objects (e.g., executables, PDF files, image files, etc.) before they are allowed onto the network and/or before the objects are downloaded, installed, or used by client computing devices in the network. A “sandbox” component may analyze the behaviors of objects in a representative, replicated, or emulated environment (e.g., emulator, etc.) with representative inputs before allowing the objects to be downloaded onto a corporate network or by client computing devices. The “sandbox” blocks objects from entering the network that are determined to be non-benign (e.g., malware, could result in a non-benign behavior or activity, etc.). Otherwise, the sandbox “releases” the object so that it can be downloaded, installed, and/or used by a client computing device (e.g., in the enterprise or corporate network).

Due to the characteristics and uses of modern malware (i.e., “CurrentGen” malware), conventional “sandboxes” are not adequate for protecting corporate networks and their client computing devices. For example, modern malware may be targeted and tailored to the specific characteristics of the system under attack. In addition, modern malware may also be polymorphic, metamorphic, multi-vector, encrypted, and/or includes time bombs or logic bombs. These characteristics may allow modern malware to circumvent conventional sandbox and security solutions.

Modern malware may be polymorphic in that the same logical behavior can come in many different concrete forms, and the core functionality of a malicious application (e.g., read information from an address book, and send it to a remote server) could be implemented using variety of different bytes or different machine code. Therefore, simply evaluating the bytes or machine code to spot malware patterns may not reveal the nature of the code. As a result, the security solution cannot simply compare the bytes or machine code to the bytes or machine code of known malware.

Modern malware may be metamorphic in that it keeps changing its appearance. The first time metamorphic malware transits/executes, it appears as one program. The next time the metamorphic malware transits/executes, it looks like another program or application. Therefore, security solutions cannot rely on fingerprint analysis (e.g., comparing the fingerprint of an executing application to a fingerprint stored in memory of one particular appearance of each malware) as that malware's fingerprint will continuously change.

Modern malware may be encrypted and/or obfuscated. Static analysis techniques that evaluate the raw bytes in order to understand what the malware is doing may not be able to detect when a software application is malware. This is because the payload encrypted in the malware, and must be decrypted to reveal the true nature of the malware. However, decrypting the payload typically requires executing the application, thereby releasing the malware on the system.

Due to these and other characteristics and features of modern malware, it may be challenging to identify and respond to malware at the network/enterprise level unless the entire system is emulated (via “full system emulation”) and the object is fully analyzed. Yet, emulating the entire system and fully analyzing each and every object is an extremely slow process, and could have a significant negative impact on the user experience (i.e., by making the client device seem slow or non-responsive).

Various embodiments include security solutions that overcome the above-mentioned limitations of conventional solutions. Security solutions according to various embodiments may target or address the above-mentioned characteristics and features of modern malware. Since such non-benign applications or behaviors may cause degradation in the performance and functioning of the computing device or corporate network, the various embodiments improve the performance and functioning of the computing device and corporate network by protecting them against malware and other non-benign applications.

In some embodiments, the security solutions may be configured to cause a processor in a computing device to perform operations for protecting computing devices from non-benign software applications (e.g., malware, performance degrading apps, etc.). The processor may perform canonicalization operations to incrementally standardize, normalize and/or canonicalize a software package and unpack its associated software application in layers.

In some embodiments, the canonicalization operations may include a code transformation operation, a canonical code ordering operation, a semantic NOP (no-operation) removal operation, a deadcode elimination operation, a canonical register naming operation, and/or a code unpacking operation.

The security solution may perform a “canonical code ordering” operation to undo obfuscations that reorder a code segment through direct or indirect jumps. In an embodiment, the security solution may be configured to perform canonical code ordering operations that include “inlining” the target basic blocks of direct jumps. In an embodiment, the security solution may perform canonical code ordering operations that include inlining indirect jumps immediately after one of the immediate jump predecessors of the target basic blocks.

The security solution may perform a semantic NOP (no-operation) removal operation and/or a deadcode elimination operation to undo obfuscations that insert semantic NOPs and functionally dead code. An example of a semantic NOP is a read-write operation that reads a register value from a register and writes that value back into that same register. An example of a “semantic NOP removal” operation that may be performed by the security solution is a “backward dataflow analysis” operation. A backward dataflow analysis operation may allow the security solution to identify a semantic NOP. The backward dataflow analysis operation may also allow the security solution to undue obfuscations caused by the semantic NOP.

The security solution may perform a “canonical register naming” operation to detect and/or undo obfuscations that rename registers, which may obfuscate a program by changing the concrete bit representation of that program. In some embodiments, the canonical register naming operations may include a “register allocation” operation that assigns or reassigns registers. The registers may be assigned using a canonical naming order. The canonical naming order may be an alphabetical naming order.

The security solution may perform a “code unpacking” operation to undo obfuscations that pack the payload one or more times. The code unpacking operations may include emulation operations and/or native execution operations. During emulation or native execution, the security system may monitor writes to memory and control flow transfers. In response to detecting that control flow has been transferred to a previously written memory location, the security system may generate a scan of the memory page that contains the memory location. The security system may then use the generated scan to determine or discover newly unpacked code, which could contain a payload that is of interest to the security system. A “payload of interest” may be a non-benign payload or a payload that better reveals the core functionality of the software application program.

The security solution may be configured to cause the processor in the computing device to perform any or all of the above described canonicalization operations. The performance of such canonicalization operations may generate a canonical representation, which may be an information structure (e.g., array, program graph, map, etc.) that characterizes all or portions of the functionality provided by the software application program at a particular level of detail or abstraction. The security solution may generate the canonical representations at varying layers of representation and detail. In some embodiments, the security solution may be configured to generate the canonical representations progressively such that each subsequent canonical representation characterizes a more fundamental functionality of the software application program than the preceding canonical representation. The security solution may also progressively generate the canonical representations such that each subsequent canonical representation characterizes a functionality at a higher level of detail and/or at a level that is closer to a core functionality than its preceding canonical representation.

The processor may use the results of these canonicalization operations (e.g., canonical representations at varying layers of representation and detail, etc.) to determine or reveal the core functionality of the associated software application. The processor may then evaluate each unpacked layer (or each layer of canonical representation) to determine whether the core functionality is benign or non-benign.

In some embodiments, the processor may perform control flow dependency analysis operations, perform data-flow dependency analysis operations, perform symbolic or concolic analysis operations, and identify inputs that should be used to exercise the application (e.g., via an emulator, detonator, etc.) based on the information that is gained from the analysis operations. The processor may use the identified inputs to exercise the application, collect behavior information from or during the exercising of the application, use the collected behavior information to generate a signature (e.g., for each layer of canonical representation), compare the generated signature to a signature stored in a database of known behaviors, generate first comparison results, and use the comparison results to determine whether the generated signatures match a known behavior. The processor may also use the results generated by canonicalizing the software package (e.g., each layer of canonical representation) to generate a trace (e.g., an instruction trace, memory trace, sys-call trace, behavior trace, etc.), compare the generated trace to information stored in a trace databased to generate second comparison results, and use the second comparison results to determine whether the software application is non-benign.

In some embodiments, the processor may be configured to use the data and values generated via the performance of the control flow dependency analysis operations and/or the data and values generated via the performance of data-flow dependency analysis operations to generate a pruned program graph that is smaller, more optimized, less obfuscated and/or less complex than the current program graph. The processor may use the pruned program graph in subsequent iterations of the canonicalization and/or analysis operations to improve performance. The processor may continuously or repeatedly generate leaner or more pruned program graphs until the core functionality is revealed.

In some embodiments, the processor may determine that the core functionality of the software application has been revealed (and thus is accessible for analysis) by progressively generating canonical representations such that each subsequent canonical representation characterizes a functionality of the software application at a higher level of detail and/or at a level that is closer to the core functionality of the software application than its preceding canonical representation until the last generated canonical representation does not characterize the functionality at a higher level of detail than its preceding canonical representation. In such embodiments, the processor may determine that the core functionality of the software application has not been revealed (and not yet accessible for analysis) in response to determining that the last generated canonical representation characterizes the functionality at a higher level of detail than its preceding canonical representation. In that case, the processor may generate another canonical representation, and continue doing so until no further level of detail is exposed to ensure that the core functionality of the software application is revealed, and thus accessible for analysis.

In some embodiments, processor may determine that the core functionality of the software application is revealed and thus accessible for analysis by performing a compiler transformation operation that de-obfuscates a software package associated with the software application in layers such that each subsequent layer is less obfuscated than its preceding layer, and determining that that the core functionality of the software application has been revealed when the software package cannot be further de-obfuscated and/or when the performance of additional de-obfuscation operations will not produce a layer that is less obfuscated than the last-produced layer. The processor may determine that the core functionality of the software application has not been revealed (and is not yet accessible for analysis) in response to determining that the last-generated layer is less obfuscated than its preceding layer, that the software package may be further de-obfuscated, and/or that the performance of additional de-obfuscation operations will produce another layer that is less obfuscated than its preceding layer. In that case, the processor may perform another compiler transformation operation on the software package, and continue doing so until no further reduction in obfuscation in the software package is achieved to ensure that the core functionality of the software application is revealed, and thus accessible for analysis.

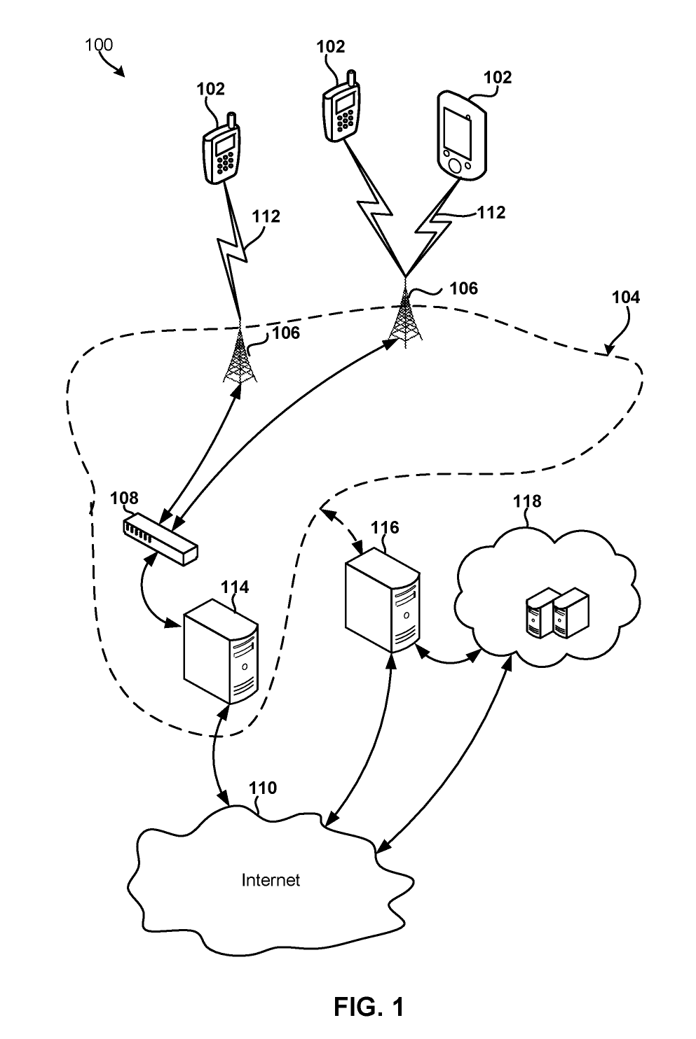

Various embodiments may be implemented within a variety of communication systems, such as the example communication system 100 illustrated in FIG. 1. A typical cell telephone network 104 includes a plurality of cell base stations 106 coupled to a network operations center 108, which operates to connect calls (e.g., voice calls or video calls) and data between client computing devices 102 (e.g., cell phones, laptops, tablets, etc.) and other network destinations, such as via telephone land lines (e.g., a plain old telephone service (POTS) network, not shown) and the Internet 110. Communications between the client computing devices 102 and the telephone network 104 may be accomplished via two-way wireless communication links 112, such as fourth generation (4G), third generation (3G), code division multiple access (CDMA), time division multiple access (TDMA), long term evolution (LTE) and/or other mobile communication technologies. The telephone network 104 may also include one or more servers 114 coupled to or within the network operations center 108 that provide a connection to the Internet 110.

In some embodiments, the communication system 100 may include various components that allow the client computing devices 102 to communicate with the network via any of a variety of wired and wireless technologies. The wireless technologies may include peer-to-peer or short-range wireless technologies, such as Bluetooth® and WiFi, that enable high speed communications between computing devices that are within a relatively short distance of one another (e.g., 100 meters or less).

The communication system 100 may further include network servers 116 connected to the telephone network 104 and to the Internet 110. The connection between the network servers 116 and the telephone network 104 may be through the Internet 110 or through a private network (as illustrated by the dashed arrows). A network server 116 may also be implemented as a server within the network infrastructure of a cloud service provider network 118. Communication between the network server 116 and the client computing devices 102 may be achieved through the telephone network 104, the internet 110, private network (not illustrated), or any combination thereof. In an embodiment, the network server 116 may be configured to establish a secure communication link to the client computing device 102, and securely communicate information (e.g., behavior information, classifier models, behavior vectors, etc.) via the secure communication link.

The client computing devices 102 may request the download of software applications from a private network, application download service, or cloud service provider network 118. The network server 116 may be equipped with an emulator, exerciser, and/or detonator components that are configured to receive or intercept a software application that is requested by a client computing device 102. The emulator, exerciser, and/or detonator components may also be configured to emulate the client computing device 102, exercise or stress test the received/intercepted software application, and perform various analysis operations to determine whether the software application is benign or non-benign.

For example, in some embodiments, the network server 116 may be equipped with a detonator component that is configured to receive data collected from independent executions of different instances of the same software application on different client computing devices. The detonator component may combine the received data, and use the combined data to identify unexplored code space or potential code paths for evaluation. The detonator component may exercise the software application through the identified unexplored code space or identified potential code paths via an emulator (e.g., a client computing device emulator), and generate analysis results that include, represent, or analyze the information generated during the exercise. The network server 116 may determine whether the software application is non-benign based on the generated analysis results.

Thus, the network server 116 may be configured to intercept software applications before they are downloaded to the client computing device 102, emulate a client computing device 102, exercise or stress test the intercepted software applications, and determine whether any of the intercepted software applications are benign or non-benign. The network server 116 may also be configured to evaluate software applications after they are downloaded by a client computing device 102 in order to determine whether the software applications are benign or non-benign.

In some embodiments, the network server 116 may be equipped with a behavior-based security system that is configured to determine whether the software application is benign or non-benign. In an embodiment, the behavior-based security system may be configured to generate machine learning classifier models (e.g., an information structure that includes component lists, decision nodes, etc.), generate behavior vectors (e.g., an information structure that characterizes a device behavior and/or represents collected behavior information via a plurality of numbers or symbols), apply the generated behavior vectors to the generated machine learning classifier models to generate an analysis result, and use the generated analysis result to classify the software application as benign or non-benign.

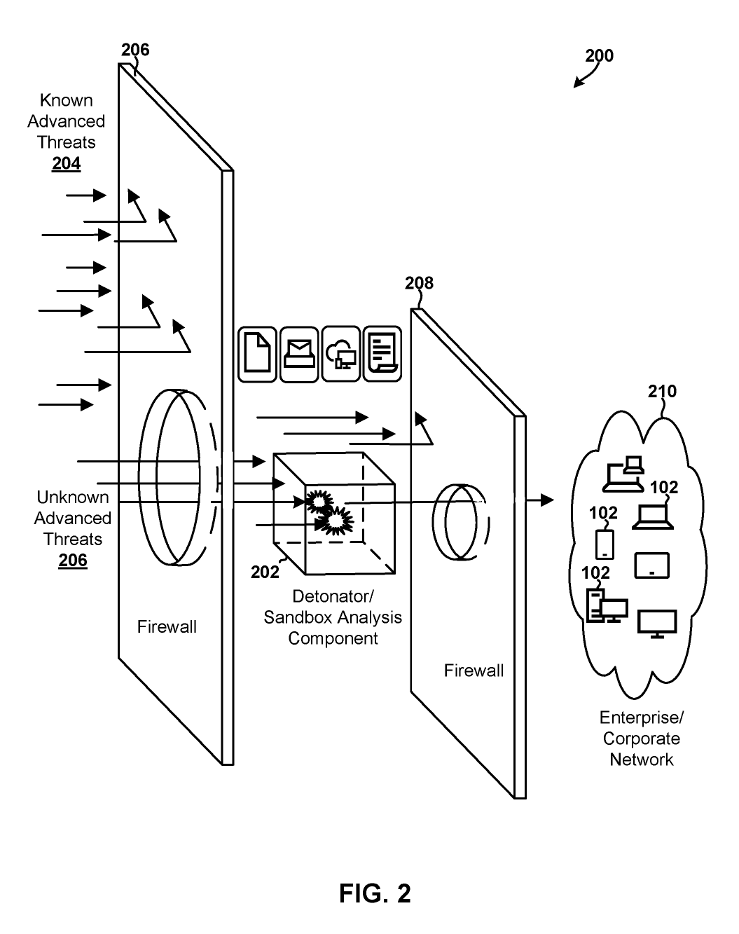

FIG. 2 illustrates an example security system 200 that may be configured to evaluate objects (e.g., PDFs, JPG images, executable files, software application programs, an application package or APK, etc.) in accordance with the various embodiments. In the example illustrated in FIG. 2, objects that are identified as known advanced threats 204 are blocked by a first layer firewall 206 component. Objects that are unknown advanced threats 206 pass through the first layer firewall 206, but must pass through a sandbox component 202 and/or a second layer firewall 208 before reaching client computing devices 102 that are in an enterprise or corporate network 210.

In some embodiments, the sandbox component 202 may include a detonator component (not illustrated separately in FIG. 2).

The sandbox component 202 may be configured to repeatedly or recursively “canonicalize” the object in order to peel off layers of obfuscation and junk. After each iteration or application of the canonicalization operations (or at each level of canonicalization), the sandbox component 202 may exercise or stress test the object in a replicated computing environment (e.g., emulator, etc.), identify its core features (its core behavior, core feature, core functionality, etc.), generate a trace of core features, and compare the generated trace to traces of known behaviors. The sandbox component 202 may perform these operations recursively, repeatedly or continuously until the generated trace matches a trace of a known behavior, or until a time, processing, or battery threshold is reached. In some embodiments, the sandbox component 202 may be configured to perform any or all of the above-described operations repeatedly until the behavior trace matches a trace stored in memory or until a core functionality of the software application is revealed. The sandbox component 202 may be configured to recognize or determine whether a core functionality of the software application has been revealed and is accessible for analysis, or that a further recursive performance of the operations should be performed based on determining whether that the last generated canonical representation characterizes the functionality at a higher level of detail than its preceding canonical representation, whether the software package may be further de-obfuscated, whether the performance of additional de-obfuscation operations will produce another layer that is less obfuscated than its preceding layer, etc.

The sandbox component 202 may classify the object as benign when the generated trace matches a trace of a known good/benign behavior. The sandbox component 202 may classify the object as non-benign when the generated trace matches a trace of a known bad/non-benign behavior.

The sandbox component 202 may allow benign objects to pass through the second layer firewall 206 so that they may be downloaded onto the corporate network 210, executed by client computing devices 102, etc. The sandbox component 202 may be configured to quarantine objects classified as non-benign, and prevent them from being downloaded onto the corporate network 210 and/or prevent them from being installed or executed by client computing devices 102.

In some embodiments, the sandbox component 202 may be configured to receive exercise information (e.g., confidence level, a list of explored activities, a list of explored graphical user interface (GUI) screens, a list of unexplored activities, a list of unexplored GUI screens, a list of unexplored behaviors, hardware configuration information, software configuration information, behavior vectors, etc.) from the client computing device 102. The sandbox component 202 may also be configured to send various different types of information to the client computing device 102, such as risk scores, security ratings, behavior vectors, classifier models, etc.

In some embodiments, the sandbox component 202 may be configured to exercise or stress test a received software application in a client computing device emulator or in a computing environment that replicates the hardware and software environments of one of the client computing devices 102.

The sandbox component 202 may be configured to identify one or more activities or behaviors of the software application and/or client computing device 102, and rank the activities or behaviors in accordance with their level of importance. The sandbox component 202 may be configured to prioritize the activities or behaviors based on their rank, and analyze the activities or behaviors in accordance with their priorities. The sandbox component 202 may be configured to generate analysis results, and use the analysis results to determine whether the identified behaviors are benign or non-benign. The sandbox component 202 may send a received software application to, or otherwise allow the software application to be received in, the client computing device 102 in response to demining that the software application or its core behaviors are benign.

In some embodiments, the client computing devices 102 may be configured to control, guide, inform, and/or issue requests to the sandbox component 202. In addition, each of the client computing devices 102 may be configured to collect and send various different types of data to the sandbox component 202, including hardware configuration information, software configuration information, information identifying a software application that is to be evaluated in the sandbox component 202, a list of activities or screens associated with the software application, a list of activities of the application that have been explored, a list of activities of the application that remain unexplored, a confidence level for the software application, a list of unexplored behaviors, collected behavior information, generated behavior vectors, classifier models, the results of its analysis operations, locations of buttons, text boxes or other electronic user input components that are displayed on the electronic display of the client device, and other similar information/data. The sandbox component 202 may be configured to receive and use this data to perform detonation operations.

In some embodiments, the sandbox component 202 may be configured to collect and combine inputs and data received from the multitude/plurality of client computing devices 302. The inputs may be provided by an on-device security mechanism. These inputs may be exchanged over a secure communication channel. These inputs may include information that captures/identifies the collective experience of many different users of the same application. Using such inputs from multiple users (or the collective experience) may allow the sandbox component 202 to evaluate the applications more comprehensively (e.g., because it can construct a more detailed and composite picture of application behavior, etc.).

In some embodiments, the sandbox component 202 may be configured to compile, determine, compute and/or update unexplored space, such as versions of the operating system that have not yet been evaluated or used, unexplored activities of a software application that have not yet been evaluated, relevant time and locations in which the software application has not been tested, the combination of hardware configuration and software configuration in which the application has not been evaluated by different users, etc.

In some embodiments, the sandbox component 202 may be configured to use different metrics (for code coverage, malware detection, etc.) to rank applications and/or select an application for evaluation. Each of these metrics may be multiplied by a weight, parameter or scaling factor, and combined together (e.g., through summation operation) in order to compute the rank. These set of weights, parameters or scaling factors may represent or be generated by a machine learning model, and the set of weights, parameters or scaling factors may be “learned” using an appropriate training dataset generated for this purpose.

In some embodiments, the sandbox component 202 may be configured to cycle a selected application through unexplored spaces and perform collaborative detonation operations. The resulting experience of executing the application at the detonator (e.g., the analysis or detonation results generated by the detonator component, etc.) may be fed back to other components in the system. These results include various elements, parameters, data fields and values, including a code coverage score and risk score, may be fed back to different mobile devices, etc. In a high-level implementation, the detonator's feedback may include the identification of suspicious or malicious or non-benign applications, etc. In a more detailed level implementation, the detonator may pinpoint specific activities or screens within applications that are suspicious, malicious or non-benign, in which case the detonator feedback to the device may include a list of suspicious or malicious or non-benign screens in the application. The operating system on the device may use any or all such information to prevent users from visiting activities or screens (e.g., activities or screens determined to be non-benign).

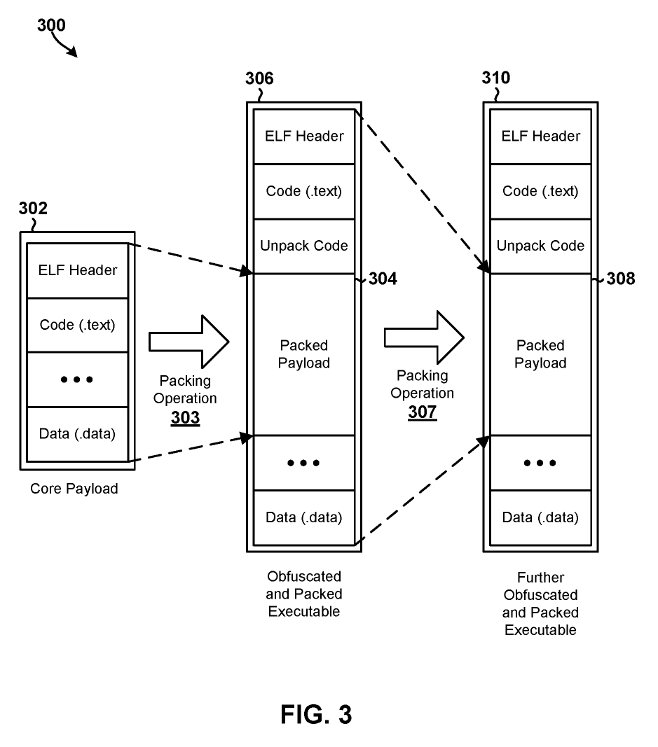

FIG. 3 illustrates an example object 300 that may be canonicalized and evaluated in accordance with the various embodiments. In the example illustrated in FIG. 3, the object 300 includes a core payload 302 that is packed (via a first packing operation 303) into a packed payload 304 of an obfuscated and packed executable 306. The obfuscated and packed executable 306 is again packed (via subsequent packing operations 307) into a further packed payload 308 of a further obfuscated and packed executable 310. When a client computing device requests to download a file (e.g., from an app store, application download service, etc.), it is the “further obfuscated and packed executable” 310 that is sent to the client.

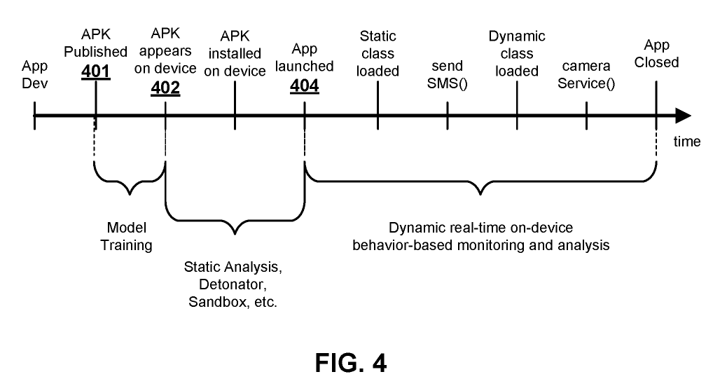

Due to its packaging, conventional security systems may not be able to readily identify or determine the nature of the core payload 302 in the object 300 before the object 300 is downloaded, installed/unpacked, and launched in the client computing device. By recursively canonicalizing the object 300, the various embodiments may characterize, classify or determine the nature of its core payload 302 (e.g., benign, non-benign, etc.) before the object 300 is downloaded, installed, or launched on the client computing device. FIG. 4 illustrates various stages in the lifecycle of a software application program.

For example, FIG. 4 illustrates that a software application program (or its associated application package or “APK”) is published to an apps store at time 401, appears on the client device at time 402, and is launched at time 404. Between time 401 and time 402, a security system could use the APK to generate training data and/or to train its security models (e.g., machine learning classifier models, etc.). A sandbox component may be configured to evaluate the software application program (or APK) between time 402 and the time 404 that the application is launched. The client computing device may also include a dynamic, real-time, on-device, and behavior-based monitoring and analysis that evaluates the software application after it is launched (e.g., after time 404).

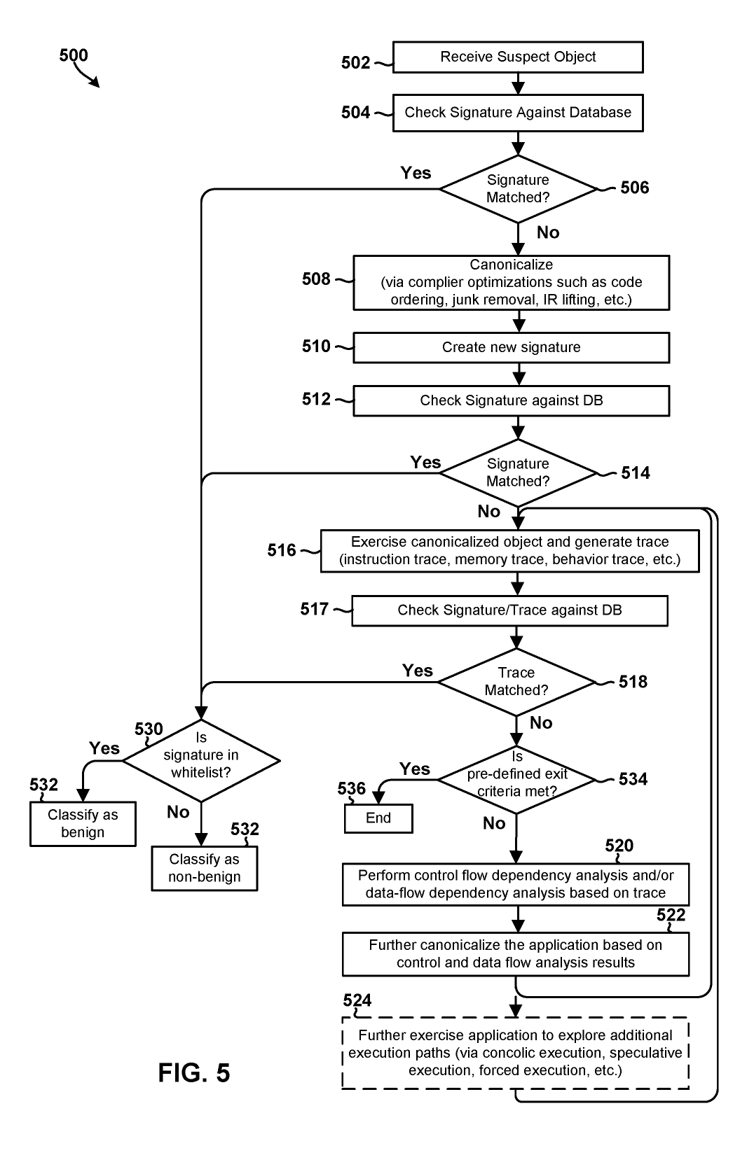

FIG. 5 illustrates a method 500 for “canonicalizing” and evaluating a software application program in order to determine whether the program is benign or non-benign in accordance with an embodiment. In block 502, a processor in a computing device may receive a suspect object. In block 504, the processor may compare a trace or signature of the received object to signatures of known behaviors stored in a signature database. In determination block 506, the processor may determine whether the signature of the received object matches any of the signatures stored in the signature database.

In response to determining that the signature of the received object matches a signature stored in the signature database (i.e., determination block 506=“Yes”), the processor may determine whether the signature is included in a whitelist in determination block 530.

In response to determining that the signature is included in the whitelist (i.e., determination block 530=“Yes”), the processor may classify the object as benign in block 532.

In response to determining that the signature is not included in the whitelist (i.e., determination block 530=“No”), the processor may classify the object as non-benign (e.g., malware, etc.).

In response to determining that the signature of the received object does not match a signature stored in the signature database (i.e., determination block 506=“No”), the processor may canonicalize the object in block 508 to remove a layer of packaging, junk, obfuscation, etc. In some embodiments, the processor may canonicalize the object via compiler optimization techniques, such as code ordering, junk removal, IR lifting, etc.

In block 510, the processor may create or generate a new signature for the canonicalized object.

In block 512, the processor may compare the generated signature of the canonicalized object to the signatures of known behaviors stored in the signature database.

In determination block 514, the processor may determine (e.g., based on the comparison results) whether the signature of the object matches any of the signatures stored in the signature database.

In response to determining that the signature of the object matches a signature stored in the signature database (i.e., determination block 514=“Yes”), the processor may determine whether the signature of the received object is included in a signature whitelist in determination block 530.

On the other hand, in response to determining that the signature of the object does not match any of the signatures stored in the signature database (i.e., determination block 514=“No”), the processor may exercise the canonicalized object and generate a new trace (e.g., an instruction trace, memory trace, behavior trace, etc.) or signature in block 516.

In block 517, the processor may compare the updated signature or new trace to the information stored in the database (e.g., the signatures stored in the signature database, etc.).

In determination block 518, the processor may determine whether the generated trace/signature matches a trace or signature of a known behavior stored in memory (e.g., the signature database).

In response to determining that the trace/signature matches (i.e., determination block 518=“Yes”), the processor may determine whether the signature of the received object is included in a signature whitelist in determination block 530.

In response to determining that the trace/signature does not match any trace or signature store in memory (i.e., determination block 518=“No”), the processor may determine whether a predefined criterion has been met in determination block 534. For example, in determination block 534, the processor may determine whether the application has (or has not) been fully explored on all possible inputs, whether the analysis operations have (or have not) timed out, whether the operations have (or have not) been running for longer than a pre-defined total analysis time, etc.

In response to determining that the predefined criterion has been met (i.e., determination block 534=“Yes”), the processor may mark the process as “complete” and/or end the operations of the current instance of method 500 in block 536.

In response to determining that the predefined criteria have not been met (i.e., determination block 534=“No”), the processor may perform control flow dependency analysis and/or data-flow dependency analysis operations based on the trace in block 520.

In block 522, the processor may further canonicalize the object to remove another layer of packaging, junk, obfuscation, etc. In some embodiments, the processor may canonicalize the object based on the results of the control and/or data flow analysis operations in block 522.

In optional block 524, the processor may further exercise the application to explore additional execution paths (via concolic execution, speculative execution, forced execution, etc.).

The processor may repeat the operations in blocks 516-524 until the generated trace/signature matches a trace or signature stored in memory.

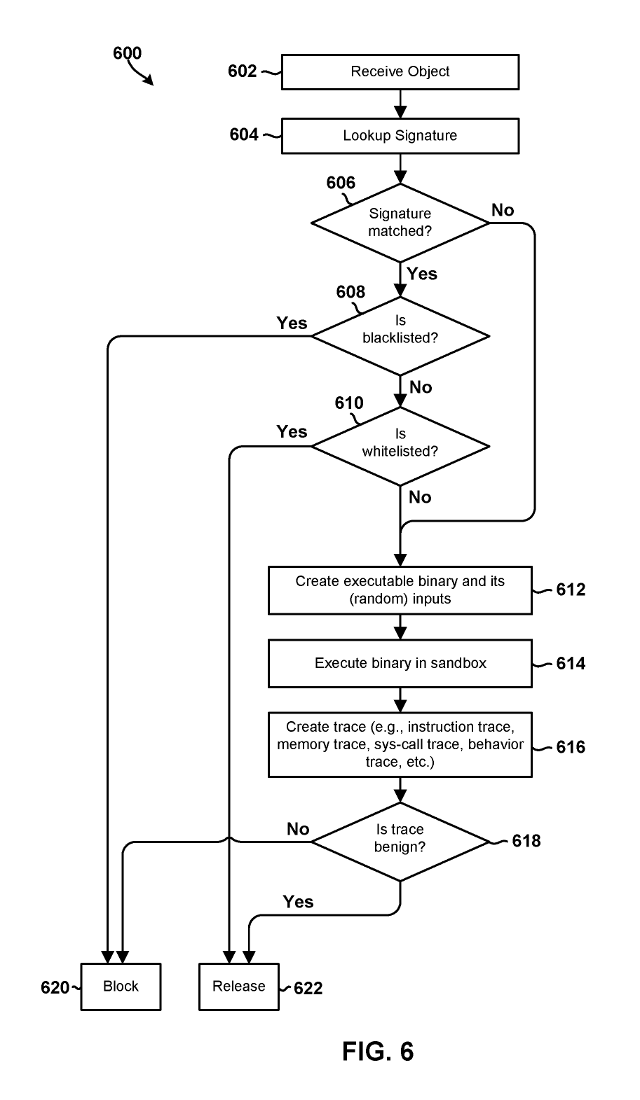

FIGS. 6-8 illustrate additional methods for “canonicalizing” and evaluating a software application program in accordance with various embodiments.

FIG. 6 illustrates a method 600 for determining whether to release or block an object (e.g., a software application, executable, PDF file, image file, etc.) in accordance with the various embodiments. The method 600 may be performed by a processor in a computing device (e.g., 116) within a network.

In block 602, the processor in the computing device may receive an object and determine that the received object requires evaluation (e.g., via a security solution of the computing device, etc.).

In block 604, the processor may compare a trace or signature of the received object to signatures of known behaviors stored in a signature database, and determine whether the signature of the received object matches any of the signatures stored in the signature database in determination block 606.

In response to determining that the signature of the received object matches a signature stored in the signature database (i.e., determination block 606=“Yes”), the processor may determine whether the signature is included in a blacklist in determination block 608. In response to determining that the signature is included in the blacklist (i.e., determination block 608=“Yes”), the processor may block/terminate/delete the object in block 620. In response to determining that the signature is not included in the blacklist (i.e., determination block 608=“No”), the processor may determine whether the signature is included in a whitelist in determination block 610. In response to determining that the signature is included in the whitelist (i.e., determination block 610=“Yes”), the processor may release the object block 622. It should be noted that the determinations in blocks 608 and 610 may be performed in the opposite order (checking the whitelist before the blacklist) or within a single operation (e.g., when the whitelist and blacklist are within a single or combined database).

In response to determining that the signature of the received object does not match any of the signatures stored in the signature database (i.e., determination block 606=“No”) or in response to determining that the signature is not included in either a blacklist or a whitelist (i.e., determination blocks 608 and 610=“No”), the processor may create executable binary and generate inputs (e.g., random inputs, pseudo-random inputs, etc.) for exercising the binary in block 612.

In block 614, the processor may execute binary via sandbox component, and create or generate a trace (e.g., instruction trace, memory trace, sys-call trace, behavior trace, etc.) in block 616.

In determination block 618, the processor may evaluate the generated trace data or the trace created in block 616 in order to determine whether the trace is benign. In response to determining that the trace is not benign (i.e., determination block 618=“No”), the processor may block/terminate/delete the object in block 620. In response to determining that the trace is benign (i.e., determination block 618=“Yes”), the processor may release the object in block 622.

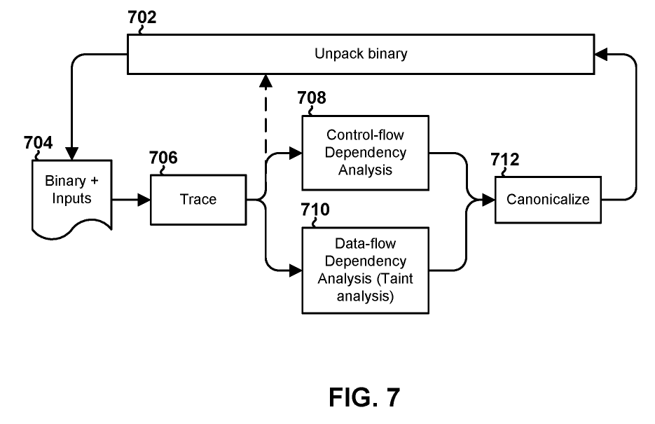

FIG. 7 illustrates a method 700 for repeatedly canonicalizing and evaluating an object (e.g., a software application, executable, PDF file, image file, etc.) on multiple runs/executions in order to reveal and analyze its core functionality in layers in accordance with some embodiments. The method 700 may be performed by a processor or processing core in a computing device. In some embodiments, the method 700 may be performed after determining that the signature of a received object does not match any of the signatures stored in a signature database and/or that the signature is not included in either a blacklist or a whitelist. In some embodiments, the method 700 may be performed as part of the operations of blocks 612-616 of the method 600 illustrated in FIG. 6.

In block 702, a processor in a computing device may unpack the binary code associated with a received object. In block 704, the processor may create executable binary and generate inputs (e.g., random inputs, pseudo-random inputs, etc.) for exercising the binary.

In block 706, the processor may execute the created binary (via sandbox component in block 614), monitor the execution of the binary to collect trace data, and use the collected trace data to create a trace.

In block 708 the processor may perform control-flow dependency analysis operations. In block 710, the processor may perform data-flow dependency analysis and/or taint analysis operations.

In block 712, the processor may use the analysis results generated in blocks 708 and/or 710 to canonicalize the object.

In block 702, the processor may further unpack the canonicalized object/binary. The processor may perform these operations of the method 700 continuously or repeatedly until the computing device determines that the application has been fully explored on all possible inputs, that the analysis operations have time out, that a processing, battery or power consumption threshold has been reached, or that the object (or software application) has been classified as benign or non-benign with a sufficiently high degree of confidence.

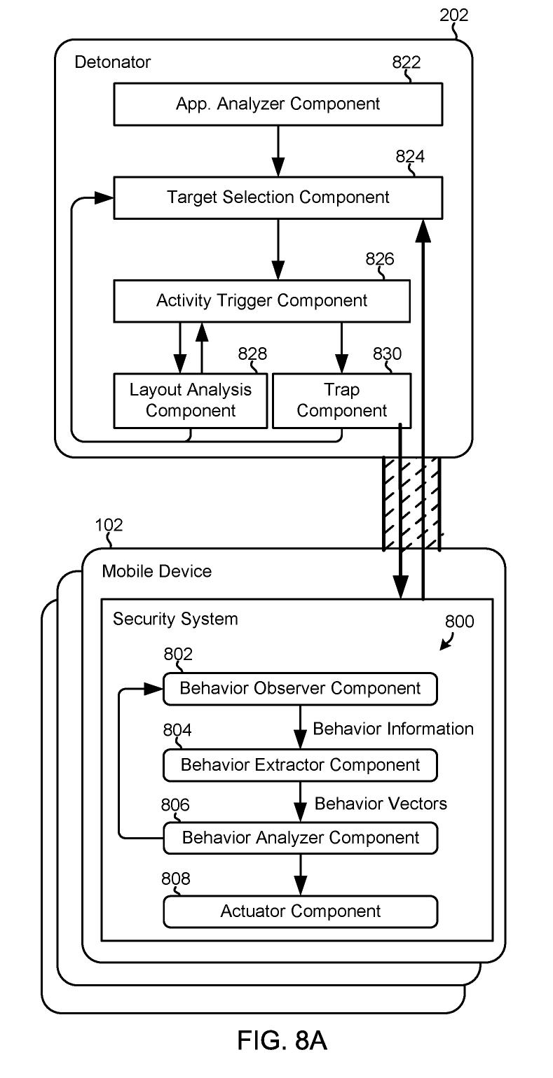

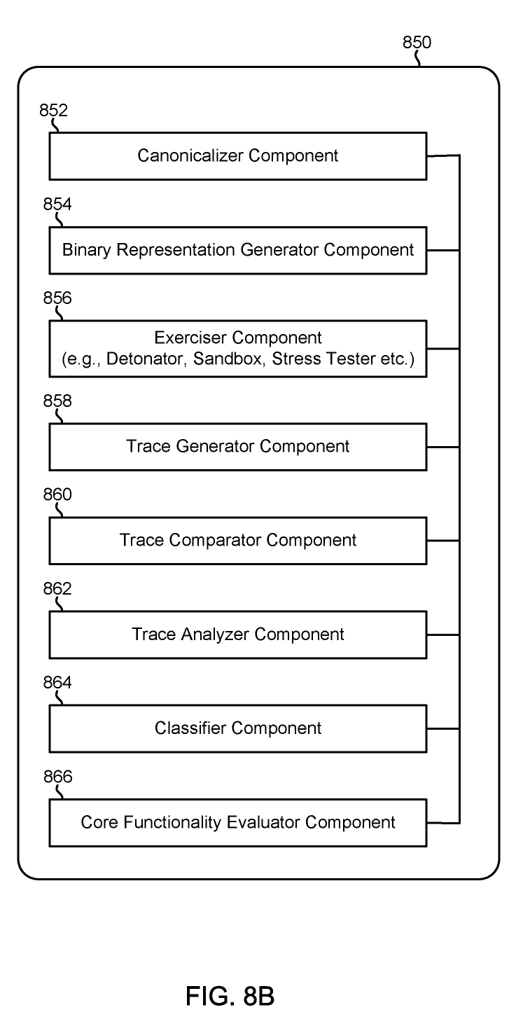

FIG. 8A illustrates various components and information flows in a system that includes a sandbox component 202 executing in a server and a client computing device 102 configured in accordance with the various embodiments. In the example illustrated in FIG. 8A, the sandbox component 202 includes an application analyzer component 822, a target selection component 824, an activity trigger component 826, a layout analysis component 828, and a trap component 830. The client computing device 102 includes a security system 800 that includes a behavior observer component 802, a behavior extractor component 804, a behavior analyzer component 806, and an actuator component 808.

As mentioned above, the sandbox component 202 may be configured to exercise a software application (e.g., in a client computing device emulator) to identify one or more behaviors of the software application and/or client computing device 102, and determine whether the identified behaviors are benign or non-benign. As part of these operations, the sandbox component 202 may perform static and/or dynamic analysis operations.

Static analysis operations that may be performed by the sandbox component 202 may include analyzing byte code (e.g., code of a software application uploaded to an application download service) to identify code paths, evaluating the intent of the software application (e.g., to determine whether it is malicious, etc.), and performing other similar operations to identify all or many of the possible operations or behavior of the software application.

The dynamic analysis operations that may be performed by the sandbox component 202 may include executing the byte code via an emulator (e.g., in the cloud, etc.) to determine all or many of its behaviors and/or to identify non-benign behaviors.

In an embodiment, the sandbox component 202 may be configured to use a combination of the information generated from the static and dynamic analysis operations (e.g., a combination of the static and dynamic analysis results) to determine whether the software application or behavior is benign or non-benign. For example, the sandbox component 202 may be configured to use static analysis to populate a behavior information structure with expected behaviors based on application programming interface (API) usage and/or code paths, and to use dynamic analysis to populate the behavior information structure based on emulated behaviors and their associated statistics, such as the frequency that the features were excited or used. The sandbox component 202 may then apply the behavior information structure to a machine learning classifier to generate an analysis result, and use the analysis result to determine whether the application is benign or non-benign.

The application analyzer component 822 may be configured to perform static and/or dynamic analysis operations to identify one or more behaviors and determine whether the identified behaviors are benign or non-benign. For example, for each activity (i.e., GUI screen), the application analyzer component 822 may perform any of a variety of operations, such as count the number of lines of code, count the number of sensitive/interesting API calls, examine its corresponding source code, call methods to unroll source code or operations/activities, examine the resulting source code, recursively count the number of lines of code, recursively count the number of sensitive/interesting API calls, output the total number of lines of code reachable from an activity, output the total number of sensitive/interesting API calls reachable from an activity, etc. The application analyzer component 822 may also be used to generate the activity transition graph for the given application that captures how the different activities (i.e., GUI screens) are linked to one another.

The target selection component 824 may be configured to identify and select high value target activities (e.g., according to the use case, based on heuristics, based on the outcome of the analysis performed by the application analyzer component 822, as well as the exercise information received from the client computing device, etc.). The target selection component 824 may also rank activities or activity classes according to the cumulative number of lines of code, number of sensitive or interesting API calls made in the source code, etc. Examples of sensitive APIs for malware detection may include takePicture, getDeviceId, etc. Examples of APIs of interest for energy bug detection may include Wakelock.acquire, Wakelock.release, etc. The target selection component 824 may also prioritize visiting of activities according to the ranks, and select the targets based on the ranks and/or priorities.

Once the current target activity is reached and explored, a new target may be selected by the target selection component 824. In an embodiment, this may be accomplished by comparing the number of sensitive/interesting API calls that are actually made during runtime with the number of sensitive/interesting API calls that are determined by the application analyzer component 822. Further, based on the observed runtime behavior exhibited by the application, some of the activities (including those that have been explored already) may be re-ranked and explored/exercised again on the emulator.

Based on the activity transition graph determined in the application analyzer component 822, the activity trigger component 826 may determine how to trigger a sequence of activities that will lead to the selected target activities, identify entry point activities from the manifest file of the application, for example, and/or emulate, trigger, or execute the determined sequence of activities using the Monkey tool.

The layout analysis component 828 may be configured to analyze the source code and/or evaluate the layout of display or output screens to identify the different GUI controls (button, text boxes, etc.) visible on the GUI screen, their location, and other properties such as whether a button is clickable.

The trap component 830 may be configured to trap or cause a target behavior. In some embodiments, this may include monitoring activities of the software application to collect behavior information, using the collected behavior information to generate behavior vectors, applying the behavior vectors to classifier models to generate analysis results, and using the analysis results to determine whether a software application or device behavior is benign or non-benign.

Each behavior vector may be a behavior information structure that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used. As an example, the trap component 830 may generate a behavior vector that includes a “location_background” data field whose value identifies the number or rate that the software application accessed location information when it was operating in a background state. This allows the trap component 830 to analyze this execution state information independent of and/or in parallel with the other observed/monitored activities of the software application. Generating the behavior vector in this manner also allows the system to aggregate information (e.g., frequency or rate) over time.

A classifier model may be a behavior model that includes data and/or information structures (e.g., feature vectors, behavior vectors, component lists, decision trees, decision nodes, etc.) that may be used by the computing device processor to evaluate a specific feature or embodiment of the device's behavior. A classifier model may also include decision criteria for monitoring and/or analyzing a number of features, factors, data points, entries, APIs, states, conditions, behaviors, software applications, processes, operations, components, etc. (herein collectively referred to as “features”) in the computing device.

In the client computing device 102, the behavior observer component 802 may be configured to instrument or coordinate various application programming interfaces (APIs), registers, counters or other components (herein collectively “instrumented components”) at various levels of the client computing device 102. The behavior observer component 802 may repeatedly or continuously (or near continuously) monitor activities of the client computing device 102 by collecting behavior information from the instrumented components. In an embodiment, this may be accomplished by reading information from API log files stored in a memory of the client computing device 102.

The behavior observer component 802 may communicate (e.g., via a memory write operation, function call, etc.) the collected behavior information to the behavior extractor component 804, which may use the collected behavior information to generate behavior information structures that each represent or characterize many or all of the observed behaviors that are associated with a specific software application, module, component, task, or process of the client computing device. Each behavior information structure may be a behavior vector that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used.

The behavior extractor component 804 may communicate (e.g., via a memory write operation, function call, etc.) the generated behavior information structures to the behavior analyzer component 806. The behavior analyzer component 806 may apply the behavior information structures to classifier models to generate analysis results, and use the analysis results to determine whether a software application or device behavior is benign or non-benign (e.g., malicious, poorly written, performance-degrading, etc.).

The behavior analyzer component 806 may be configured to notify the actuator component 808 that an activity or behavior is not benign. In response, the actuator component 808 may perform various actions or operations to heal, cure, isolate, or otherwise fix identified problems. For example, the actuator component 808 may be configured to terminate a software application or process when the result of applying the behavior information structure to the classifier model (e.g., by the analyzer module) indicates that a software application or process is not benign.

The behavior analyzer component 806 also may be configured to notify the behavior observer component 802 in response to determining that a device behavior is suspicious (i.e., in response to determining that the results of the analysis operations are not sufficient to classify the behavior as either benign or non-benign). In response, the behavior observer component 802 may adjust the granularity of its observations (i.e., the level of detail at which client computing device features are monitored) and/or change the factors/behaviors that are observed based on information received from the behavior analyzer component 806 (e.g., results of the real□time analysis operations), generate or collect new or additional behavior information, and send the new/additional information to the behavior analyzer component 806 for further analysis. Such feedback communications between the behavior observer and behavior analyzer components 802, 806 enable the client computing device processor to recursively increase the granularity of the observations (i.e., make finer or more detailed observations) or change the features/behaviors that are observed until behavior is classified as either benign or non-benign, until a processing or battery consumption threshold is reached, or until the client computing device processor determines that the source of the suspicious or performance-degrading behavior cannot be identified from further increases in observation granularity. Such feedback communications also enable the client computing device 102 to adjust or modify the classifier models locally in the client computing device 102 without consuming an excessive amount of the client computing device's 102 processing, memory, or energy resources.

FIG. 8B illustrates various components and information flows in a computing system 850 configured to protect a computing device from a non-benign software application in accordance with various embodiments. In the example illustrated in FIG. 8B, the computing system 850 includes a canonicalizer component 852, a binary representation generator component 854, an exerciser component 856, a trace generator component 858, a trace comparator component 860, a trace analyzer component 862, a classifier component 864, and a core functionality evaluator component 866. In the various embodiments, any or all of the components 852-866 may be included in, or used to implement any of functions of, the sandbox component 202 or the security system 800 discussed above with reference to FIG. 8A.

The canonicalizer component 852 may be configured to canonicalize the software application and/or generate a canonicalized representation of the software application. As part of these operations, the canonicalizer component 852 may perform any or all of a code transformation operation, a canonical code ordering operation, a semantic no-operation removal operation, a deadcode elimination operation, a canonical register naming operation, a code unpacking operation, or a compiler transformation operation that de-obfuscates a software package associated with the software application. The canonicalizer component 852 may unpack the software application in layers.

The binary representation generator component 854 may be configured to generate an executable binary representation of the software application based on a canonicalized representation. The executable binary representation may be an executable object or information structure that includes or represents text, processor executable software instructions and/or data in a format that is suitable for execution and/or which represents a functionality of the software application at a specific layer or level of abstraction or representation. In some embodiments, the binary representation generator component 854 may be included as part of the canonicalizer component 852.

The exerciser component 856 may be configured to exercise the software application by executing an executable binary representation in a replicated computing environment to generate exercise information or a behavior trace. In some embodiments, the exerciser component 856 may be included as part of a sandboxed detonator component (e.g., detonator 202 illustrated in FIGS. 2 and 8A).

In some embodiments, the exerciser component 856 may be configured to identify a target activity of the software application. The exerciser component 856 may generate an activity transition graph based on the software application. The exerciser component 856 may use the activity transition graph to identify a sequence of activities that will lead to the identified target activity, and trigger the identified sequence of activities.

In some embodiments, the exerciser component 856 may be configured to stress test the software application in an emulator, collect behavior information from behaviors exhibited by the software application during the stress testing, and analyze the collected behavior information to identify the core functionality of the software application. The computing system 850 may generate a signature based on the identified core functionality, compare the generated signature to a signature stored in a database of known behaviors, classify the software application as benign or non-benign based on whether the signature matches a signature stored in memory.

The trace generator component 858 may be configured to receive and use the output from the exerciser component 856 to generate a trace, such as an instruction trace, memory trace, sys-call trace, behavior trace, etc. The trace comparator component 860 may be configured to determine whether the behavior trace matches a trace stored in memory. The trace analyzer component 862 may be configured to perform analysis operations based on the behavior trace to generate analysis results. In various embodiments, the analysis operations may include any or all of a control flow dependency analysis operation, a data-flow dependency analysis operation, a symbolic analysis operation, and/or a concolic analysis operation. The trace analyzer component 862 may also evaluate each unpacked layer or each canonicalized representation to determine whether the software application is non-benign. In some embodiments, the trace analyzer component 862 may be included in, or used to implement any of functions of, the security system 800 illustrated in FIG. 8A.

In some embodiments, the canonicalizer component 852 may be configured to use the analysis results generated by the trace analyzer component 862 to further canonicalize the software application and generate a more detailed canonicalized representation of the software application. In some embodiments, the canonicalizer component 852 may be configured to use information gained from performance of the control flow dependency analysis operation, the data-flow dependency analysis operation, the symbolic analysis operation, or the concolic analysis operation to identify inputs for exercising the software application. The exerciser component 856 may use the more detailed canonicalized representation to further exercise the software application in the replicated computing environment and generate a new or updated behavior trace. The exerciser component 856 may use the identified inputs to further exercise the software application in the replicated computing environment. The computing system 850 may perform any or all of the above described operations recursively or repeatedly until a generated trace matches a trace stored in memory, until a core functionality of the software application is revealed, or until a time, processing, or battery threshold is reached. The computing system 850 may be configured to recognize or determine whether a core functionality of the software application has been revealed, or that a further recursive performance of the operations should be performed based on whether the last generated canonical representation characterizes the functionality at a higher level of detail than its preceding canonical representation.

The classifier component 864 may be configured to classify the software application as benign or non-benign. For example, the classifier component 864 may classify the software application as benign in response to determining that the behavior trace matches a trace stored in a whitelist. The classifier component 864 may classify the software application as non-benign in response to determining that the behavior trace matches a trace stored in a blacklist. In some embodiments, the classifier component 864 may be included in, or used to implement any of functions of, the security system 800 illustrated in FIG. 8A.

The core functionality evaluator component 866 may be configured to determine whether the core functionality is benign or non-benign. The core functionality evaluator component 866 may perform an identified core functionality on the computing device to collect behavior information, and use the collected behavior information to determine whether the core functionality is non-benign. In some embodiments, the core functionality evaluator component 866 may perform the identified core functionality by executing a canonicalized representation or binary representation associated with the identified core functionality.

In some embodiments, the core functionality evaluator component 866 may be configured to perform static analysis operations to generate static analysis results, perform dynamic analysis operations to generate dynamic analysis results, and determine whether the core functionality is non-benign based on a combination of the static and dynamic analysis results.

In some embodiments, the core functionality evaluator component 866 may be configured to generate a machine learning classifier model, generate a behavior vector that characterizes an observed device behavior, apply the generated behavior vector to the generated machine learning classifier models to generate an analysis result, and determine whether the core functionality is non-benign based on the generated analysis result. In some embodiments, the core functionality evaluator component 866 may be included in, or used to implement any of functions of, the security system 800 illustrated in FIG. 8A.

Various embodiments may implement and use a variety of data flow tracking solutions and taint analysis techniques. Generally, data flow tracking solutions, such as FlowDroid, are effective tools for identifying not-benign software applications (e.g., software that is malicious, poorly written, incompatible with the device, etc.). Briefly, data flow tracking solutions monitor data flows between a source component (e.g., a file, process, remote server, etc.) and a sink component (e.g., another file, database, electronic display, transmission point, etc.) to identify software applications that are using the data improperly. For example, a data flow tracking solution may include annotating, marking, or tagging data with identifiers (e.g., tracking or taint information) as it flows from the source component to the sink component, determining whether the data is associated with the appropriate identifiers in the sink component, and invoking a security system or agent to generate an exception or error message when the data is not associated with the appropriate identifiers or when the data is associated with inappropriate identifiers. As a further example, a source component may associate a source ID value to a unit of data, each intermediate component that processes that unit of data may communicate the source ID value along with the data unit, and the sink component may use the source ID value to determine whether the data unit originates from, or is associated with, an authorized, trusted, approved, or otherwise appropriate source component. The computing device may then generate an error message or throw an exception when the sink component determines that the data unit is not associated with an appropriate (e.g., authorized, trusted, approved, etc.) source component.

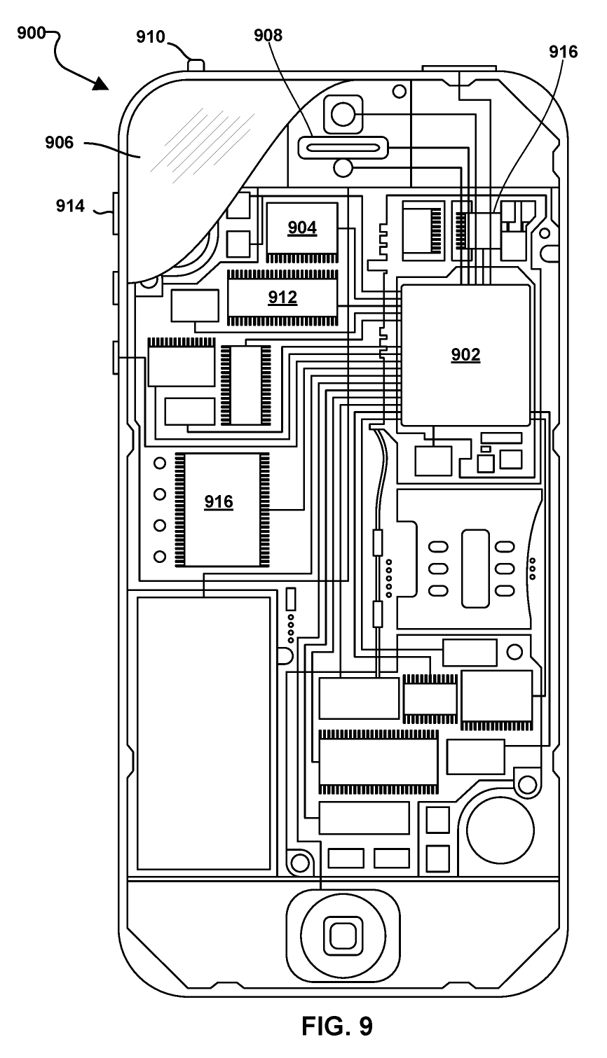

The various embodiments may be implemented on a variety of client computing devices, an example of which is illustrated in FIG. 9. Specifically, FIG. 9 is a system block diagram of a client computing device in the form of a smartphone/cell phone 900 suitable for use with any of the embodiments. The cell phone 900 may include a processor 902 coupled to internal memory 904, a display 906, and a speaker 908. Additionally, the cell phone 900 may include an antenna 910 for sending and receiving electromagnetic radiation that may be connected to a wireless data link and/or cellular telephone (or wireless) transceiver 912 coupled to the processor 902. Cell phones 900 typically also include menu selection buttons or rocker switches 914 for receiving user inputs.

A typical cell phone 900 also includes a sound encoding/decoding (CODEC) circuit 916 that digitizes sound received from a microphone into data packets suitable for wireless transmission and decodes received sound data packets to generate analog signals that are provided to the speaker 908 to generate sound. Also, one or more of the processor 902, wireless transceiver 912 and CODEC 916 may include a digital signal processor (DSP) circuit (not shown separately). The cell phone 900 may further include a ZigBee transceiver (i.e., an Institute of Electrical and Electronics Engineers (IEEE) 802.15.4 transceiver) for low-power short-range communications between wireless devices, or other similar communication circuitry (e.g., circuitry implementing the Bluetooth® or WiFi protocols, etc.).

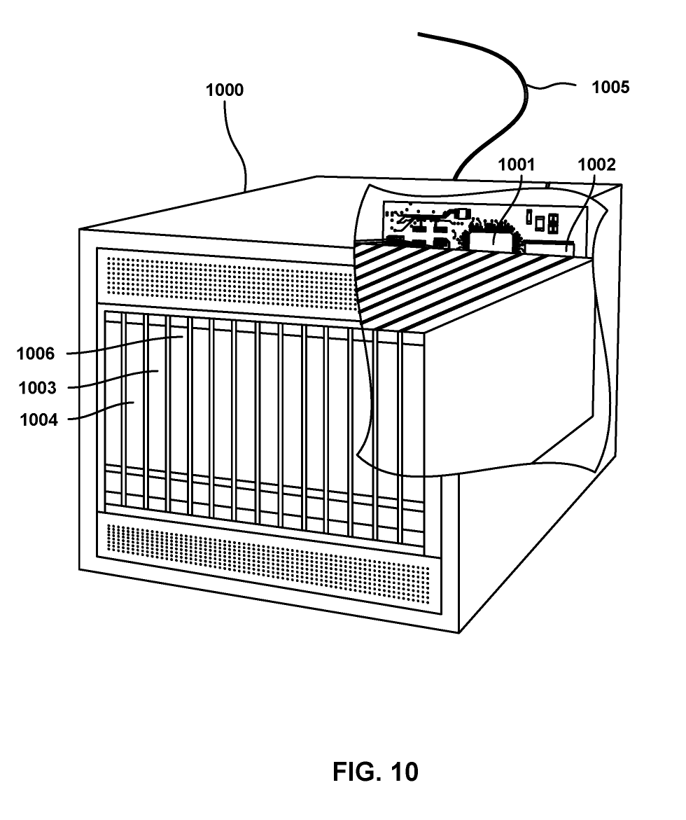

The embodiments and network servers described above may be implemented in variety of commercially available server devices, such as the server 1000 illustrated in FIG. 10. Such a server 1000 typically includes a processor 1001 coupled to volatile memory 1002 and a large capacity nonvolatile memory, such as a disk drive 1003. The server 1000 may also include a floppy disc drive, compact disc (CD) or DVD disc drive 1004 coupled to the processor 1001. The server 1000 may also include network access ports 1006 coupled to the processor 1001 for establishing data connections with a network 1005, such as a local area network coupled to other communication system computers and servers.

The processors 902, 1001, may be any programmable microprocessor, microcomputer or multiple processor chip or chips that can be configured by software instructions (applications) to perform a variety of functions, including the functions of the various embodiments described below. In some client computing devices, multiple processors 902 may be provided, such as one processor dedicated to wireless communication functions and one processor dedicated to running other applications. Typically, software applications may be stored in the internal memory 904, 1002, before they are accessed and loaded into the processor 902, 1001. The processor 902 may include internal memory sufficient to store the application software instructions. In some servers, the processor 1001 may include internal memory sufficient to store the application software instructions. In some devices, the secure memory may be in a separate memory chip coupled to the processor 1001. The internal memory 904, 1002 may be a volatile or nonvolatile memory, such as flash memory, or a mixture of both. For the purposes of this description, a general reference to memory refers to all memory accessible by the processor 902, 1001, including internal memory 904, 1002, removable memory plugged into the device, and memory within the processor 902, 1001 itself.

Modern computing devices enable their users to download and execute a variety of software applications from application download services (e.g., Apple App Store, Windows Store, Google play, etc.) or the Internet. Many of these applications are susceptible to and/or contain malware, adware, bugs, or other non-benign elements. As a result, downloading and executing these applications on a computing device may degrade the performance of the corporate network and/or the computing devices. Therefore, it is important to ensure that only benign applications are downloaded into computing devices or corporate networks.

Recently, Google/Android has developed a tool called “The Monkey” that allows users to “stress-test” software applications. This tool may be run as an emulator to generate pseudo-random streams of user events (e.g., clicks, touches, gestures, etc.) and system-level events (e.g., display settings changed event, session ending event, etc.) that developers may use to stress-test software applications. While such conventional tools (e.g., The Monkey, etc.) may be useful to some extent, they are, however, unsuitable for systematic/intelligent/smart evaluation of “Apps” or software applications with rich graphical user interface typical of software applications that are designed for execution and use in mobile computing devices or other resource-constrained devices.

There are a number of limitations with conventional stress-test tools that prevent such tools from intelligently identifying malware and/or other non-benign applications before the applications are downloaded and executed on a client computing device. First, most conventional emulators are designed for execution on a desktop environment and/or for emulating software applications that are designed for execution in a desktop environment. Desktop applications (i.e., software applications that are designed for execution in a desktop environment) are developed at a much slower rate than apps (i.e., software applications that are designed primarily for execution in a mobile or resource-constrained environment). For this reason, conventional solutions typically do not include the features and functionality for evaluating applications quickly, efficiently (i.e., without using extensive processing or battery resources), or adaptively (i.e., based on real data collected in the “wild” or “field” by other mobile computing devices that execute the same or similar applications).

Further, mobile computing devices are resource constrained systems that have relatively limited processing, memory and energy resources, and these conventional solutions may require the execution of computationally-intensive processes in the mobile computing device. As such, implementing or performing these conventional solutions in a mobile computing device may have a significant negative and/or user-perceivable impact on the responsiveness, performance, or power consumption characteristics of the mobile computing device.

In addition, many conventional solutions (e.g., “The Monkey,” etc.) generate a pseudo-random streams of events that cause the software application to perform a limited number of operations. These streams may only be used to evaluate a limited number of conditions, features, or factors. Yet, modern mobile computing devices are highly configurable and complex systems, and include a large variety of conditions, factors and features that could require analysis to identify a non-benign behavior. As a result, conventional solutions such as The Monkey do not fully stress test apps or mobile computing devices applications because they cannot evaluate all the conditions, features, or factors that could require analysis in mobile computing devices. For example, The Monkey and other conventional tools do not adequately identify the presence, existence or locations of buttons, text boxes, or other electronic user input components that are displayed on the electronic display screens of mobile computing devices. As a result, these solutions cannot adequately stress test or evaluate these features (e.g., electronic user input components, etc.) to determining whether a mobile computing device application is benign or non-benign.

Further, conventional tools do not intelligently determine the number of activities or screens used by a software application or mobile computing devices, or the relative importance of individual activities or screens. In addition, conventional tools use fabricated test data (i.e., data that is determined in advance of a program's execution) to evaluative software applications, as opposed to real or live data that is collected from the use of the software application on mobile computing devices. For all these reasons, conventional tools for stress testing software applications do not adequately or fully “exercise” or stress test software applications that are designed for execution on mobile computing devices, and are otherwise not suitable for identifying non-benign applications before they are downloaded onto a corporate network and/or before they are downloaded, installed, or executed on mobile computing devices.

The various embodiments include computing devices that are configured to overcome the above-mentioned limitations of conventional solutions, and identify non-benign applications before the applications are downloaded onto a corporate or private network and/or before the applications are downloaded and installed on a client computing device.

In some embodiments, a computing device processor may be configured to receive a suspect object (e.g., software application program package, APK, etc.), use compiler optimization techniques to canonicalize the object and/or generate a canonicalized object, create or generate a new signature based on the canonicalized object, exercise the canonicalized object, and generate a new trace or signature based on the results generated when exercising the canonicalized object.

The computing device processor may determine whether a “predefined criterion” has been met, such as whether the application has (or has not) been fully explored on all possible inputs, whether the analysis operations have (or have not) timed out, whether the operations have (or have not) been running for longer than a pre-defined total analysis time, etc. In response to determining that the predefined criterion has not yet been met, the computing device processor may perform control flow dependency analysis and/or data-flow dependency analysis operations, further canonicalize the object based on the results of the control and/or data flow analysis operations, further exercise the application to explore additional execution paths, and generate a new trace or signature on the results generated when further exercising the further canonicalized object. The computing device processor may perform any or all of these operations repeatedly or recursively until the generated trace/signature matches a trace or signature stored in memory, until the core functionality of the object is revealed, until it is determined that the object may not be further canonicalized, or until a processing, memory, or battery threshold is reached. The computing device processor may recognize or determine that the core functionality of the object has been revealed and is accessible for analysis, or that a further recursive performance of the operations should be performed based on whether the last generated canonical representation characterizes the functionality at a higher level of detail than its preceding canonical representation.

The various embodiments may include methods of protecting computing devices from non-benign software applications, which may include canonicalizing a software package to determine core functionality of its associated software application, and determining whether the core functionality is non-benign. In some embodiments, the methods may include canonicalizing the software application to generate a first canonicalized representation of the software application, and generating an executable binary representation of the software application based on the first canonicalized representation. Such embodiments may further include exercising the software application by executing the generated executable binary representation in a replicated computing environment to generate a behavior trace. Such embodiments may further include determining whether the behavior trace matches a trace stored in memory, and performing analysis operations based on the behavior trace to generate analysis results in response to determining that the behavior trace does not match any trace stored in memory. Such embodiments may further include using the analysis results to further canonicalize the software application and generate a more detailed canonicalized representation of the software application. Such embodiments may further include using the more detailed canonicalized representation to further exercise the software application in the replicated computing environment to update the behavior trace. Such embodiments may further include repeatedly performing the operations of performing the analysis operations based on the behavior trace to generate the analysis results, canonicalizing the software application, and using the analysis results to further canonicalize the software application and generate the more detailed canonicalized representation of the software application until the behavior trace matches a trace stored in memory or until a core functionality of the software application is revealed. Such embodiments may further include recognizing or determining whether a core functionality of the software application has been revealed and is accessible for analysis, or that a further recursive performance of the operations should be performed based on whether the last generated canonical representation characterizes the functionality at a higher level of detail than its preceding canonical representation. Such embodiments may further include classifying the software application as benign or non-benign in response to determining that the behavior trace matches a trace stored in memory, and determining whether the core functionality is non-benign in response to determining that the core functionality of the software application has been revealed.

In an embodiment, canonicalizing the software package to determine the core functionality of its associated software application may include unpacking a software application in layers. In a further embodiment, the method may include evaluating each unpacked layer to determine whether the software application is non-benign. In a further embodiment, the method may include using information gained from control flow dependency analysis, data-flow dependency analysis, or symbolic or concolic analysis to identify inputs that should be used to exercise the application, and using the identified inputs to exercise the application. In a further embodiment, using the identified inputs to exercise the application may include executing a binary representation of the software application in a sandboxed detonator component. In a further embodiment, the method may include collecting behavior information from exercising the application, using the collected behavior information to generate a signature, and comparing the generated signature to a signature stored in a database of known behaviors. In a further embodiment, the method may include generating a trace based on a result of canonicalizing the software package. In a further embodiment, the method may include comparing the generated trace to information stored in a trace databased in order to determine whether the software application is non-benign. In a further embodiment, canonicalizing the software package to determine the core functionality of its associated software application may include performing compiler transformation operations that de-obfuscate the software package in layers.

Further embodiments may include a computing device having a memory, and a processor coupled to the memory and configured with processor-executable instructions to perform operations including canonicalizing a software package to determine core functionality of its associated software application, and determining whether the core functionality is non-benign. In a further embodiment, the processor may be configured with processor-executable instructions to perform operations such that canonicalizing the software package to determine the core functionality of its associated software application may include unpacking a software application in layers. In a further embodiment, the processor may be configured with processor-executable instructions to perform operations further including evaluating each unpacked layer to determine whether the software application is non-benign. In a further embodiment, the processor may be configured with processor-executable instructions to perform operations further including using information gained from control flow dependency analysis, data-flow dependency analysis, or symbolic or concolic analysis to identify inputs that should be used to exercise the application, and using the identified inputs to exercise the application. In a further embodiment, the processor may be configured with processor-executable instructions to perform operations further including collecting behavior information from exercising the application, using the collected behavior information to generate a signature, and comparing the generated signature to a signature stored in a database of known behaviors. In a further embodiment, the processor may be configured with processor-executable instructions to perform operations further including generating a trace based on a result of canonicalizing the software package. In a further embodiment, the processor may be configured with processor-executable instructions to perform operations further including comparing the generated trace to information stored in a trace databased in order to determine whether the software application is non-benign.

Further embodiments may include a computing device having: a canonicalizer component configured to canonicalize a software application to generate a first canonicalized representation of the software application; a binary representation generator component configured to generate an executable binary representation of the software application based on the first canonicalized representation; an exerciser component configured to execute the generated executable binary representation in a replicated computing environment to generate exercise information; a trace generator component configured to generate a behavior trace based on the exercise information; a trace comparator component configured to determine whether the behavior trace matches a trace stored in memory; and a trace analyzer component configured to perform analysis operations based on the behavior trace to generate analysis results in response to the trace comparator component determining that the behavior trace does not match any trace stored in memory. The canonicalizer component may be further configured to use the analysis results to further canonicalize the software application and generate a more detailed canonicalized representation of the software application. The exerciser component may be further configured to use the more detailed canonicalized representation to further exercise the software application in the replicated computing environment to generate updated exercise information that is used by the trace generator component to update the behavior trace. In some embodiments, one or more of the canonicalizer component, the binary representation generator component, the exerciser component, the trace generator component, the trace comparator component, and the trace analyzer component may be further configured to repeatedly perform the operations of performing the analysis operations based on the behavior trace to generate the analysis results, canonicalizing the software application, and using the analysis results to further canonicalize the software application and generate the more detailed canonicalized representation of the software application until the behavior trace matches a trace stored in memory or until a core functionality of the software application is revealed. One or more of the canonicalizer component, the binary representation generator component, the exerciser component, the trace generator component, the trace comparator component, and the trace analyzer component may be configured to recognize or determine whether a core functionality of the software application has been revealed and is accessible for analysis, or that a further recursive performance of the operations should be performed based on whether the last generated canonical representation characterizes the functionality at a higher level of detail than its preceding canonical representation. The computing device may include a classifier component configured to classify the software application as benign or non-benign in response to determining that the behavior trace matches a trace stored in memory, and a core functionality evaluator component configured to determine whether the core functionality is non-benign in response to determining that the core functionality of the software application has been revealed.

Further embodiments may include a computing device having means for canonicalizing a software package to determine core functionality of its associated software application, and means for determining whether the core functionality is non-benign. In a further embodiment, the means for canonicalizing the software package to determine the core functionality of its associated software application may include means for unpacking a software application in layers. In a further embodiment, the computing device may include means for evaluating each unpacked layer to determine whether the software application is non-benign. In a further embodiment, the computing device may include means for using information gained from control flow dependency analysis, data-flow dependency analysis, or symbolic or concolic analysis to identify inputs that should be used to exercise the application, and means for using the identified inputs to exercise the application. In a further embodiment, the computing device may include means for collecting behavior information from exercising the application, means for using the collected behavior information to generate a signature, and means for comparing the generated signature to a signature stored in a database of known behaviors. In a further embodiment, the computing device may include means for generating a trace based on a result of canonicalizing the software package. In a further embodiment, the computing device may include means for comparing the generated trace to information stored in a trace databased in order to determine whether the software application is non-benign.

Further embodiments may include a non-transitory processor-readable storage medium having stored thereon processor executable instructions configured to cause a processor of a computing device to perform operations that include canonicalizing a software package to determine core functionality of its associated software application, and determining whether the core functionality is non-benign. In a further embodiment, the stored processor executable instructions may be configured to cause a processor to perform operations such that canonicalizing the software package to determine the core functionality of its associated software application may include unpacking a software application in layers. In a further embodiment, the stored processor executable instructions may be configured to cause a processor to perform operations further including evaluating each unpacked layer to determine whether the software application is non-benign. In a further embodiment, the stored processor executable instructions may be configured to cause a processor to perform operations further including using information gained from control flow dependency analysis, data-flow dependency analysis, or symbolic or concolic analysis to identify inputs that should be used to exercise the application, and using the identified inputs to exercise the application. In a further embodiment, the stored processor executable instructions may be configured to cause a processor to perform operations further including collecting behavior information from exercising the application, using the collected behavior information to generate a signature, and comparing the generated signature to a signature stored in a database of known behaviors. In a further embodiment, the stored processor executable instructions may be configured to cause a processor to perform operations further including generating a trace based on a result of canonicalizing the software package. In a further embodiment, the stored processor executable instructions may be configured to cause a processor to perform operations further including comparing the generated trace to information stored in a trace databased in order to determine whether the software application is non-benign.

As used in this application, the terms “component,” “module,” “system” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of protecting computing devices from non-benign software applications, comprising:
performing canonicalization operations on a software application until a behavior trace matches a trace stored in memory or until a core functionality of the software application is accessible for analysis; and
determining whether the core functionality is non-benign in response to determining that the core functionality of the software application is accessible for analysis.

2. The method of claim 1, further comprising:
classifying the software application as benign or non-benign in response to determining that the behavior trace matches a trace stored in memory.

3. The method of claim 1, wherein performing canonicalization operations on the software package until a behavior trace matches a trace stored in memory or until a core functionality of the software application is accessible comprises:
repeatedly performing analysis operations based on the behavior trace to generate analysis results, canonicalizing the software application to generate a canonicalized representation of the software application, using the analysis results to further canonicalize the software application and generate a more detailed canonicalized representation of the software application, and updating the behavior trace by using the more detailed canonicalized representation to exercise the software application in a replicated computing environment until the behavior trace matches a trace stored in memory or until the core functionality of the software application is accessible for analysis.

4. The method of claim 3, further comprising:
canonicalizing the software application to generate a first canonicalized representation of the software application;
generating an executable binary representation of the software application based on the first canonicalized representation; and
exercising the software application by executing the generated executable binary representation in the replicated computing environment to generate an initial behavior trace.

5. The method of claim 4, further comprising:
determining whether the initial behavior trace matches a trace stored in memory; and
performing analysis operations based on the initial behavior trace to generate analysis results in response to determining that the initial behavior trace does not match any trace stored in memory.

6. The method of claim 1, wherein performing canonicalization operations on the software application comprises performing:
a code transformation operation;
a canonical code ordering operation;
a semantic no-operation removal operation;
a deadcode elimination operation;
a canonical register naming operation; or
a code unpacking operation.

7. The method of claim 1, wherein performing canonicalization operations on the software application comprises performing a compiler transformation operation that de-obfuscates a software package associated with the software application.

8. The method of claim 4, wherein canonicalizing the software application to generate the first canonicalized representation of the software application comprises unpacking the software application in layers.

9. The method of claim 8, wherein repeatedly performing the operations of performing the analysis operations based on the behavior trace to generate the analysis results, canonicalizing the software application to generate a canonicalized representation of the software application, using the analysis results to further canonicalize the software application and generate the more detailed canonicalized representation of the software application, and updating the behavior trace by using the more detailed canonicalized representation to exercise the software application in a replicated computing environment until the behavior trace matches a trace stored in memory or until the core functionality of the software application is accessible for analysis comprises evaluating each unpacked layer to determine whether the software application is non-benign.

10. The method of claim 3, wherein performing the analysis operations based on the behavior trace to generate the analysis results comprises performing:
a control flow dependency analysis operation;
a data-flow dependency analysis operation;
a symbolic analysis operation; or
a concolic analysis operation.

11. The method of claim 3, wherein using the analysis results to further canonicalize the software application and generate the more detailed canonicalized representation of the software application comprises using information gained from performance of the control flow dependency analysis operation, the data-flow dependency analysis operation, the symbolic analysis operation, or the concolic analysis operation to identify inputs for exercising the software application.

12. The method of claim 11, wherein using the more detailed canonicalized representation to further exercise the software application in the replicated computing environment to update the behavior trace comprises using the identified inputs to further exercise the software application in the replicated computing environment.

13. The method of claim 4, wherein exercising the software application by executing the generated executable binary representation in the replicated computing environment to generate the behavior trace comprises executing the generated executable binary representation via a sandboxed detonator component to generate the behavior trace.

14. The method of claim 1, further comprising:
stress testing the software application in an emulator;
collecting behavior information from behaviors exhibited by the software application during the stress testing;
analyzing the collected behavior information to identify the core functionality of the software application;
generating a signature based on the identified core functionality; and
comparing the generated signature to another signature stored in a database of known behaviors.

15. The method of claim 2, wherein classifying the software application as benign or non-benign in response to determining that the behavior trace matches a trace stored in memory comprises:
classifying the software application as benign in response to determining that the behavior trace matches a trace stored in a whitelist; and
classifying the software application as non-benign in response to determining that the behavior trace matches a trace stored in a blacklist.

16. The method of claim 1, wherein determining whether the core functionality is non-benign in response to determining that the core functionality of the software application is accessible for analysis comprises:
performing the identified core functionality to collect behavior information; and
using the collected behavior information to determine whether the core functionality is non-benign.

17. The method of claim 1, wherein determining whether the core functionality is non-benign in response to determining that the core functionality of the software application is accessible for analysis comprises:
generating a machine learning classifier model;
generating a behavior vector that characterizes an observed device behavior;
applying the generated behavior vector to the generated machine learning classifier models to generate an analysis result; and
determining whether the core functionality is non-benign based on the generated analysis result.

18. The method of claim 1, wherein determining whether the core functionality is non-benign in response to determining that the core functionality of the software application is accessible comprises:
performing static analysis operations to generate static analysis results;
performing dynamic analysis operations to generate dynamic analysis results; and
determining whether the core functionality is non-benign based on a combination of the static and dynamic analysis results.

19. The method of claim 4, wherein exercising the software application by executing the generated executable binary representation in the replicated computing environment to generate the behavior trace comprises:
identifying a target activity of the software application;
generating an activity transition graph based on the software application;
identifying a sequence of activities that will lead to the identified target activity based on the activity transition graph; and
triggering the identified sequence of activities.

20. A computing device, comprising:
a canonicalizer component configured to perform canonicalization operations on a software application until a behavior trace matches a trace stored in memory or until a core functionality of the software application is accessible; and
a core functionality evaluator component configured to determine whether the core functionality is non-benign in response to determining that the core functionality of the software application is accessible.

21. A computing device, comprising:
a processor configured with processor-executable instructions to perform operations comprising:
performing canonicalization operations on a software application until a behavior trace matches a trace stored in memory or until a core functionality of the software application is accessible; and
determining whether the core functionality is non-benign in response to determining that the core functionality of the software application is accessible.

22. The computing device of claim 21, wherein the processor is configured with processor-executable instructions to perform operations further comprising:
classifying the software application as benign or non-benign in response to determining that the behavior trace matches a trace stored in memory.

23. The computing device of claim 21, wherein the processor is configured with processor-executable instructions to perform operations such that performing canonicalization operations on the software package until a behavior trace matches a trace stored in memory or until a core functionality of the software application is accessible comprises:
repeatedly performing analysis operations based on the behavior trace to generate analysis results, canonicalizing the software application to generate a canonicalized representation of the software application, using the analysis results to further canonicalize the software application and generate a more detailed canonicalized representation of the software application, and updating the behavior trace by using the more detailed canonicalized representation to exercise the software application in a replicated computing environment until the behavior trace matches a trace stored in memory or until the core functionality of the software application is accessible for analysis.

24. The computing device of claim 23, wherein the processor is configured with processor-executable instructions to perform operations further comprising:
canonicalizing the software application to generate a first canonicalized representation of the software application;
generating an executable binary representation of the software application based on the first canonicalized representation; and
exercising the software application by executing the generated executable binary representation in the replicated computing environment to generate an initial behavior trace.

25. The computing device of claim 21, wherein the processor is configured with processor-executable instructions to perform operations such that performing canonicalization operations on the software application comprises performing:
a code transformation operation;
a canonical code ordering operation;
a semantic no-operation removal operation;
a deadcode elimination operation;
a canonical register naming operation; or
a code unpacking operation.

26. The computing device of claim 21, wherein the processor is configured with processor-executable instructions to perform operations such that performing canonicalization operations on the software application comprises performing a compiler transformation operation that de-obfuscates a software package associated with the software application.

27. The computing device of claim 24, wherein the processor is configured with processor-executable instructions to perform operations such that:
performing analysis operations based on the behavior trace to generate the analysis results comprises performing a control flow dependency analysis operation, a data-flow dependency analysis operation, a symbolic analysis operation, or a concolic analysis operation;
using the analysis results to further canonicalize the software application and generate the more detailed canonicalized representation of the software application comprises using information gained from performance of the control flow dependency analysis operation, the data-flow dependency analysis operation, the symbolic analysis operation, or the concolic analysis operation to identify inputs for exercising the software application; and
updating the behavior trace by using the more detailed canonicalized representation to further exercise the software application in the replicated computing environment to update the behavior trace comprises using the identified inputs to further exercise the software application in the replicated computing environment.

28. The computing device of claim 21, wherein the processor is configured with processor-executable instructions to perform operations further comprising:
stress testing the software application in an emulator;
collecting behavior information from behaviors exhibited by the software application during the stress testing;
analyzing the collected behavior information to identify the core functionality of the software application;
generating a signature based on the identified core functionality; and
comparing the generated signature to another signature stored in a database of known behaviors.

29. A non-transitory computer readable storage medium having stored thereon processor-executable software instructions configured to cause a computing device processor to perform operations comprising:
performing canonicalization operations on a software application until a behavior trace matches a trace stored in memory or until a core functionality of the software application is accessible; and
determining whether the core functionality is non-benign in response to determining that the core functionality of the software application is accessible for analysis.

30. A computing device, comprising:
means for performing canonicalization operations on a software application until a behavior trace matches a trace stored in memory or until a core functionality of the software application is accessible for analysis; and
means for determining whether the core functionality is non-benign in response to determining that the core functionality of the software application is accessible for analysis.
